(19) United States
(12) Patent Application Publication
(10) Pub. No.: US 2011/0156467 A1
(43) Pub. Date: Jun. 30, 2011

(54) VEHICLE SEAT CUSHION AND MANUFACTURING METHOD THEREOF

(75) Inventors: Yoshiyuki MURATA, Okazaki-shi (JP); Tomohito NIIMI, Hekinan-shi (JP)

(73) Assignee: TOYOTA BOSHOKU KABUSHIKI KAISHA, Aichi-ken (JP)

(21) Appl. No.: 12/975,837

(22) Filed: Dec. 22, 2010

(30) Foreign Application Priority Data
Dec. 24, 2009 (JP) 2009-292491

(51) Int. Cl. B60N 2/44; B29C 44/12

(52) U.S. Cl. 297/452.48; 264/46.4

(57) ABSTRACT

A cushion has a seat portion made of polyurethane foam, and a supporting portion made of an elastic fiber laminated body. The seat portion and the supporting portion are directly joined in a state in which the elasticity of the supporting portion is maintained.

### INCORPORATION BY REFERENCE

The disclosure of Japanese Patent Application No. 2009-292491 filed on Dec. 24, 2009 including the specification, drawings and abstract is incorporated herein by reference in its entirety.

### BACKGROUND OF THE INVENTION

1. Field of the Invention

The invention relates to a vehicle seat cushion and a manufacturing method thereof.

2. Description of the Related Art

Polyurethane foam that offers excellent performance in a variety of areas (such as cushioning, durability, and vibration damping) is often used in this type of cushion. However, polyurethane foam is not easily returned to the raw material stage (i.e., polyol and isocyanate), so when considering recyclability, it is rather unsuitable material for current seat structures.

Therefore, Japanese Patent Application Publication No. 10-248685 (JP-A-10-248685) describes a cushion that has a seat portion made of a fiber laminated body, and a supporting portion made of polyurethane foam. The fiber laminated body has a structure in which natural fiber and synthetic fiber are densely entangled, and is material the offers excellent cushioning and breathability and the like. Using such a fiber laminated body as part of the cushion in this way makes it possible to minimize the amount of polyurethane foam (i.e., material with poor recyclability) that is used.

Incidentally, the cushion described above is able to be formed with a typical mold assembly (i.e., a mold assembly having a first die, a second die, and a cavity). For example, after arranging the fiber laminated body inside the cavity, polyurethane raw material (in liquid form) is poured in. Then the first die and the second die are closed together and the polyurethane raw material is expanded. At this time, the fiber laminated body becomes impregnated with the polyurethane raw material, and as a result, part of the fiber laminated body becomes hard (i.e., loses its elasticity), which may feel like a foreign body to an occupant (i.e., may make the occupant feel as if he or she is sitting on a board). Therefore, with the known related art, a film (such as a polyester film) is arranged on the fiber laminated body to prevent the fiber laminated body from becoming impregnated with the polyurethane raw material. However, using a film as described above reduces the various performances (such as breathability and cushioning) of the cushion. Therefore, the cushion according to the known related art is not a structure that can simply be used in place of a conventional cushion (i.e., a polyurethane foam cushion).

### SUMMARY OF THE INVENTION

The invention attempts to reduce the amount of polyurethane foam used, while maintaining the various performances of the cushion to the greatest extent possible.

A first aspect of the invention relates to a cushion of a vehicle seat, that includes a seat portion made of polyurethane foam, and a supporting portion made of an elastic fiber laminated body. With this kind of structure, it is desirable to be able to reduce the amount of polyurethane foam used by using the fiber laminated body, and at the same time, maintain the various performances (such as breathability and cushioning) of the cushion to the greatest extent possible.

Therefore, in the first aspect described above, the seat portion and the supporting portion are directly joined in a state in which the elasticity of the supporting portion (i.e., the fiber laminated body) described above is maintained. Joining the seat portion and the supporting portion directly (i.e., without using a film or the like) in this way makes it possible to reduce the amount of polyurethane foam used, while maintaining the various performances of the cushion to the greatest extent possible.

A second aspect of the invention relates to a manufacturing method of the cushion according to the first aspect using a mold assembly, wherein the mold assembly has a first die and a second die that is able to close together with the first die such that a cavity is formed between the first die and the second die. This manufacturing method includes a first step and a second step. In the first step, the supporting portion is arranged in the second die, and polyurethane raw material (i.e., polyol and isocyanate) is poured into the cavity. In the second step, the polyurethane raw material is expanded inside the cavity after the first die and the second die are closed together. In this second step, the polyurethane raw material (that is in liquid form) is away from the supporting portion. Moreover in this step, the polyurethane raw material that is expanding (and in a semi-hardened state) contacts the supporting portion, such that the supporting portion and the seat portion become integrated. Impregnation of the supporting portion (i.e., the fiber laminated body) with the polyurethane raw material can be prevented or reduced by avoiding contact between the liquid polyurethane raw material and the supporting portion as much as possible (i.e., by a relatively simple structure) in this way.

According to this second aspect, the cushion of the first aspect is able to be manufactured relatively easily.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a partial transparent side view of a vehicle seat;

FIG. 2A is a longitudinal sectional view of a fiber laminated body, and FIG. 2B is a longitudinal sectional view of a supporting portion; and

FIG. 3A is a longitudinal sectional view of a mold assembly during a first step, and FIG. 3B is a longitudinal sectional view of the mold assembly during a second step.

### DETAILED DESCRIPTION OF EMBODIMENTS

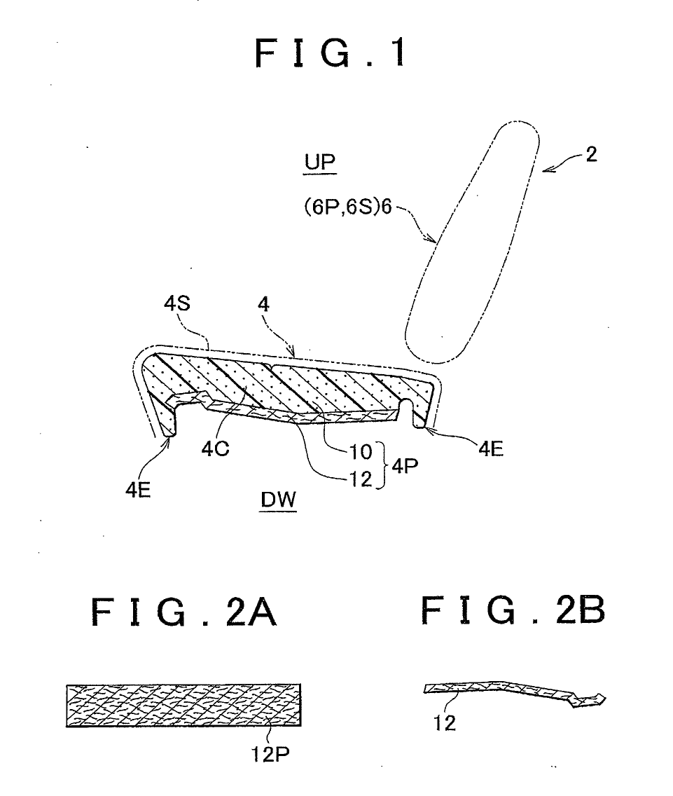

Hereinafter, example embodiments of the invention will be described with reference to FIGS. 1 to 3B. Incidentally, in the drawings, reference character UP denotes the upward direction of a mold assembly 20, and reference character DW denotes the downward direction of the mold assembly 20. A vehicle seat 2 in FIG. 1 has a seat cushion 4 and a seat back 6. Each of these members have a cushion 4P (6P) that creates the contour of the seat, and cover material 4S (6S) that covers the cushion.

[Cushion]

The cushion 4P (that is generally rectangular) is a member on which an occupant can sit, and has a center portion 4C and a curved portion 4E. The center portion 4C is a flat portion (in a longitudinal sectional view). Also, the curved portion 4E is a generally inverse L-shaped portion (in a longitudinal sectional view), and is formed at an end portion of a seat portion 10 (see FIG. 1). The cushion 4P (i.e., the center portion 4C) has the seat portion 10 made of polyurethane foam, and a supporting portion 12 made of an elastic fiber laminated body 12P. In this way, in this example embodiment, the amount of polyurethane foam used is reduced by using the supporting portion 12 (a fiber laminated body that will be described later). With this type of structure, it is desirable to be able to maintain the various performances (such as breathability and cushioning) of the cushion 4P to the greatest extent possible.

Therefore, in this example embodiment, the seat portion 10 and the supporting portion 12 are directly joined together, while maintaining the elasticity of the supporting portion 12 (i.e., the fiber laminated body). Directly joining the seat portion 10 and the supporting portion 12 in this way (i.e., joining them without using a film or the like) makes it possible to reduce the amount of polyurethane foam used, while maintaining the various performances of the cushion 4P to the greatest extent possible. The seat portion 10 and the supporting portion 12 (i.e., the cushion 4P) are able to be integrally molded using a mold assembly, for example, that will be described later. Next, the structure of the cushion 4P, together with one example of a manufacturing method thereof, will be described in detail.

[Mold Assembly]

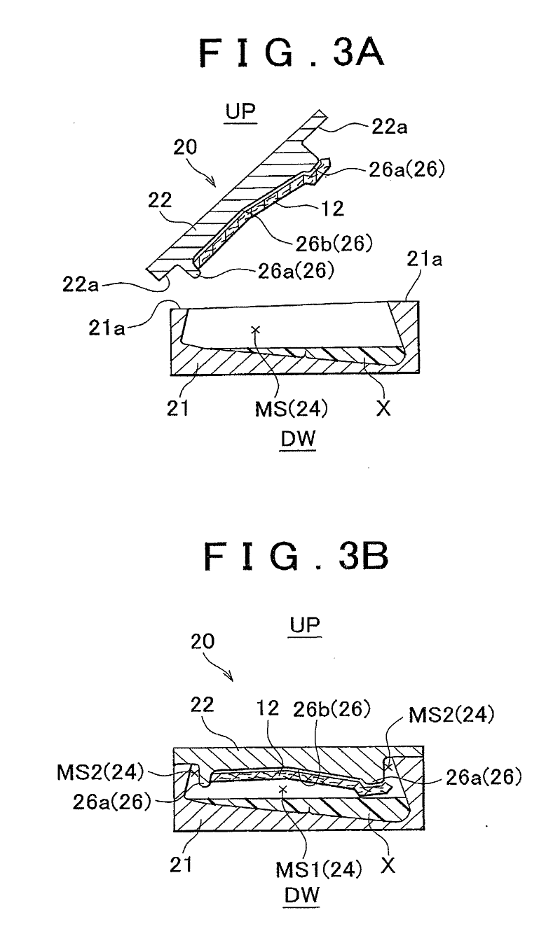

The mold assembly 20 of this example embodiment includes a first die 21, a second die 22, and a cavity 24 (see FIGS. 3A and 3B). The first die 21 (that is generally rectangular) has a molding space MS and a first die closing surface 21a. The molding space MS is a concave portion in the center of the first die 21, and becomes a space (a cavity 24) that follows the contour (i.e., the exterior shape) of the cushion 4P by closing the second die 22. The first die closing surface 21a is a flat portion that is arranged around the molding space MS. Also, the second die 22 is a flat member that is able to close together with the first die 21, and has a fitting portion 26 and a second die closing surface 22a. The fitting portion 26 is a portion that is formed in a position facing the cavity 24, and has a protruding portion 26a that stands erect from the second die 22 (i.e., from the back surface thereof), and a concave portion 26b that is surrounded by the protruding portion 26a. The second die closing surface 22a is a flat portion arranged around the fitting portion 26.

In this example embodiment, the first die 21 and the second die 22 are connected so as to be able to open and close by a hinge member or the like, not shown (see FIGS. 3A and 3B). Also, the cavity 24 is formed between the first die 21 and the second die 22 by rotating the second die 22 toward the first die 21 (i.e., closing the mold). In this example embodiment, the center portion 4C of the cushion 4P can be molded in a molding space MS1 in the center of the cavity 24 (i.e., a portion of the cavity 24) (see FIGS. 1 and 3B). Also, the curved portion 4E of the cushion 4P can be molded in a molding space MS2 between the protruding portion 26a and the first die 21 (i.e., another portion of the cavity 24).

[Manufacturing Method of the Cushion]

A manufacturing method of this example embodiment includes a preceding step, a first step, and a second step (see FIGS. 2 and 3A and 3B). Providing these steps enables the seat portion 10 and the supporting portion 12 to be integrally molded (i.e., enables the cushion 4P to be manufactured as an integrally molded article). In the preceding step, the supporting portion 12 is formed from the fiber laminated body 12P. In the first step, the supporting portion 12 is arranged in the second die 22, and polyurethane raw material X (in liquid form) is poured into the cavity 24. In the second step, the first die 21 and the second die 22 are closed together and then the polyurethane raw material X is expanded in the cavity 24.

(Preceding Step)

In the preceding step, the supporting portion 12 is formed from the fiber laminated body 12P (see FIGS. 2A and 2B). More specifically, the supporting portion 12 that has a predetermined shape is formed, for example, by compression molding the fiber laminated body 12P that is mat-shaped or plate-shaped. The supporting portion 12 of this example embodiment has a shape that follows the shape of the back surface of the center portion 4C (i.e., the concave portion 26b of the fitting portion 26). The supporting portion 12 is a member with excellent performance in a variety of areas such as cushioning and breathability because it has the appropriate elasticity derived from the fiber laminated body 12P. Incidentally, the thickness dimension and the density of the supporting portion 12 are not particularly limited. For example, when used in a typical cushion 4P (for one occupant and having a thickness dimension of approximately 80 mm), the thickness dimension of the supporting portion 12 may be set at 15 mm to 50 mm, inclusive.

Also, in the preceding step, one side of the fiber laminated body 12P or the supporting portion 12 can be melted and hardened (i.e., quenched). For example, the back surface of the supporting portion 12 (i.e., the side facing the polyurethane raw material) is melted and hardened by heating means such as a burner or a hot iron or the like. Loss of elasticity of the supporting portion 12 can be minimized by quenching only the back surface of the supporting portion 12 at this time. Quenching the back surface of the supporting portion 12 in this way makes it possible to even better suppress the impregnation of the supporting portion 12 with the polyurethane raw material X.

Also, the density of the supporting portion 12 is not particularly limited. However, when used in a typical cushion 4P (for one occupant), the density of the supporting portion 12 may be set at 10 kg/m³ to 50 kg/m³, inclusive. Here, if the density of the supporting portion 12 is less than 10 kg/m³, the durability of the cushion 4P tends to decrease. Also, if the density of the supporting portion 12 is greater than 50 kg/m³, the breathability of the cushion 4P tends to decrease. Appropriate breathability and durability of the cushion 4P can be ensured by setting the density of the supporting portion 12 at no less than 10 kg/m³ and no more than 40 kg/m³ (which is a lower density than that of polyurethane foam that will be described later).

(Fiber Laminated Body)

Here, the fiber laminated body 12P is material in which short fibers and long fibers are entangled, and is material that has excellent elasticity (see FIG. 2A). The material of the fiber laminated body 12P is not particularly limited. Some examples of fiber that may be used for the fiber laminated body 12P include natural fiber (such as animal natural fiber or plant natural fiber), synthetic fiber (such as polypropylene fiber, polyester fiber, polyamide fiber, and acrylic fiber), and a blend of these fibers. The fiber laminated body 12P is relatively easily returned to the raw material stage (such as the fiber state), and thus has better recyclability than polyurethane foam. Thermoplastic resin fiber, such as polypropylene fiber or polyester fiber, in particular, can be returned to the resin stage, i.e., raw material, easily because it melts when heated. After laminating the fibers, the fiber laminated body 12P can be formed by entangling them three-dimensionally, for example, by a method such as needle punching or spun lacing.

(First Step)

In the first step, the supporting portion 12 is arranged in the second die 22 (i.e., the fitting portion 26), and the polyurethane raw material X is poured into the first die 21 (i.e., the molding space MS) (see FIG. 3A). The supporting portion 12 is arranged so that it fits nicely in the concave portion 26b in a state surrounded by (i.e., positioned by) the protruding portion 26a. At this time, in this example embodiment, the amount of polyurethane raw material X (i.e., polyol and isocyanate) that is poured in is adjusted and the like such that there is gap (i.e., the molding space MS1 in this example embodiment) between the polyurethane raw material X (in liquid form) and the supporting portion 12 when the mold is closed. In this way, impregnation of the supporting portion 12 with the polyurethane raw material X can be minimized in the first step.

(Second Step)

In the second step, the first die 21 and the second die 22 are closed together such that the cavity 24 (which is sealed) is formed between the dies (see FIG. 3B). Next, the cavity 24 is maintained at a predetermined temperature and the polyurethane raw material X is expanded. In this example embodiment, the polyurethane raw material X during expansion (that is in a semi-hardened state) contacts the supporting portion 12 while filling the gap between the polyurethane raw material X and the supporting portion 12. The seat portion 10 and the supporting portion 12 become integrated by the expanded polyurethane raw material X completely hardening (i.e., by the formation of the seat portion 10). The supporting portion 12 after molding is arranged so as to fit nicely in the center of the back surface (i.e., the center portion 4C) of the seat portion 10. In this way, in this example embodiment, direct contact between the polyurethane raw material X (in liquid form) and the supporting portion 12 is inhibited. The seat portion 10 and the supporting portion 12 are able to be integrated by utilizing the physical change in the polyurethane raw material X that occurs during molding.

Here, the density of the seat portion 10 (i.e., the polyurethane foam) is not particularly limited. For example, when used in a typical cushion 4P (for one occupant), the density of the seat portion 10 may be set at 35 kg/m³ to 70 kg/m³, inclusive. If the density of the seat portion 10 is less than 35 kg/m³, the durability and the riding comfort of the cushion 4P tend to drastically decrease. Also, if the density of the seat portion 10 is greater than 70 kg/m³, the breathability of the cushion 4P decreases and the weight of the cushion 4P increases more than necessary. Appropriate breathability and durability and the like of the cushion 4P can be ensured by setting the density of the seat portion 10 at 40 kg/m³ to 60 kg/m³, inclusive.

As described above, in this example embodiment, impregnation of the supporting portion 12 with the polyurethane raw material X can be prevented or reduced by avoiding contact between the polyurethane raw material X and the supporting portion 12 as much as possible. As a result, the seat portion 10 and the supporting portion 12 are able to be directly joined, while maintaining the elasticity of the supporting portion 12 (i.e., the fiber laminated body) to the greatest extent possible. Also in this example embodiment, the seat portion 10 is polyurethane foam, and will therefore impart minimum discomfort to the occupant (i.e., will have a feel that is as close as possible to that of a conventional seat). Because the seat portion 10 and the supporting portion 12 are joined directly, the feeling of a foreign body caused by a film, for example, is almost non-existent.

Therefore, according to this example embodiment, the amount of polyurethane foam used can be reduced, while the various performances of the cushion 4P are maintained to the greatest extent possible. That is, the amount of polyurethane foam (i.e., material with poor recyclability) used can be minimized by using the supporting portion 12 (i.e., the fiber laminated body) for part of the cushion 4P. Moreover, supporting the seat portion 10 with the supporting portion 12 makes it possible to reduce the density of the seat portion (i.e., the polyurethane foam). Further, not using a film makes it possible to reduce both the number of parts and the cost of the cushion.

### Test Example

Hereinafter, this example embodiment will be described based on a test example, but the invention is not limited to this test example. In this test example, a vehicle seat cushion (for one occupant) was formed using the mold assembly shown in FIGS. 3A and 3B. The capacity (i.e., the volume) of the cavity was set to 0.018 m³. Also, the amount of polyurethane raw material poured into the cavity was set at 1.26 kg. Polyol (“TLB-213” made by Asahi Glass Co., Ltd.) and isocyanate (“Coronate C1021” made by Nippon Polyurethane Industry Co., Ltd.) were used as the polyurethane raw material. Also, the mold temperature (and time) during expansion molding was set to 65±3° C. (for five minutes), and the mold temperature (and time) during hardening was set to 65±3° C. (for five minutes).

### Examples

Cushions in which the thickness dimension and the density of the supporting portion (i.e., the fiber laminated body) were appropriately changed were manufactured as cushions of Examples 1 to 4 (see [Table 1]). With the cushion in each example, a fiber laminated body of polypropylene fiber was used for the fiber laminated body that becomes the supporting portion. Also, with the cushion in each example, the density of the seat portion (molded urethane (i.e., the polyurethane foam)) was set at 57 kg/m³ so that good riding comfort would not be lost.

### Comparative Examples

Cushions (made of only a seat portion (i.e., polyurethane foam)) in which the density of the seat portion was appropriately changed were manufactured as cushions of Comparative examples 1 to 3. The other molding conditions were the same as those of Examples 1 to 4.

(Test Method)

A breathability test was performed in compliance with “JISL 1096”. Also, a durability test was performed in compliance with “JISK 6400” or “JISK 6401”.

Then the durability of the cushions in each of the examples and comparative examples was determined based on the following. “A” indicates equivalency to Comparative example 1, “B” indicates equivalency to Comparative example 2, and “C” indicates equivalency to Comparative example 3.

The riding comfort of the cushions of the examples and comparative examples was determined based on the following. “A” indicates equivalency to Comparative example 1, “B” indicates equivalency to Comparative example 2, and “C” indicates equivalency to Comparative example 3.

The results of the tests are shown in Table 1 below.

TABLE 1

| | | Com- | Com- | Com- | | | | |
|---|---|---|---|---|---|---|---|---|
| | | para- | para- | para- | | | | |
| | | tive | tive | tive | | | | |
| | | ex- | ex- | ex- | Ex- | Ex- | Ex- | Ex- |
| | | ample | ample | ample | ample | ample | ample | ample |
| | | 1 | 2 | 3 | 1 | 2 | 3 | 4 |
| Molded | kg/m³ | 57 | 45 | 40 | 57 | 57 | 57 | 57 |
| urethane | | | | | | | | |
| density | | | | | | | | |
| Fiber | mm | — | — | — | 15 | 30 | 45 | 50 |
| elastic | | | | | | | | |
| body | | | | | | | | |
| thickness | | | | | | | | |
| Fiber | kg/m³ | — | — | — | 40 | 21 | 14 | 12 |
| elastic | | | | | | | | |
| body | | | | | | | | |
| density | | | | | | | | |
| Product | g | 1250 | 987 | 877 | 1188 | 987 | 779 | 702 |
| weight | | | | | | | | |
| Breatha- | cc | 7.0 | 7.9 | 8.1 | 8.5 | 9.1 | 13.2 | 16.3 |
| bility | | | | | | | | |
| Durability | — | A | B | C | A | B | B | C |
| Riding | — | A | B | C | A | A | B | B |
| comfort | | | | | | | | |

[Results and Observations]

Referring to [Table 1], it is evident that the cushions in Examples 1 to 4 have good breathability compared with the cushions in Comparative examples 1 to 3. Also, the cushions in Examples 1 to 4 are lightweight compared with the cushion in Comparative example 1, and have durability and riding comfort equal to those of Comparative examples 1 to 3. Here, the mere low density (i.e., light weight) of the cushion in Comparative example 3 adversely affects the durability and the riding comfort. On the other hand, the cushion in Example 3 was able to be made lightweight with minimal adverse affect on the durability and the riding comfort. From these results, it is evident that, with the cushions in Examples 1 to 4, the amount of polyurethane foam used was able to be reduced, while maintaining the various performances of the cushion to the greatest extent possible. From this, it is evident that the cushions in Examples 1 to 4 are Able to be favorably used in place of conventional cushions made of polyurethane foam.

The vehicle seat cushion of this example embodiment is not limited to the example embodiment described above. That is, various other example embodiments are also possible. Several will now be described. (1) In the example embodiment described above, the cushion 4P of the seat cushion 4 is given as an example. The structure of the example embodiment described above may also be applied to a cushion of any of a variety of seat structures such as the cushion 6P of the seat back 6 or the like. (2) Also, the example embodiment described above describes an example in which the supporting portion 12 is arranged on the fitting portion 26 (i.e., in the center of the second die 22). In contrast, the back surface of the second die 22 may be flush, for example, and the supporting portion 12 may be fitted to the entire back surface. In this case, a fitting portion (such as a hook member) with which the supporting portion is able be engaged may be provided on the back surface of the supporting portion.

(3) Also, the structure of the mold assembly 20 in the example embodiment described above is an example. For example, the example embodiment described above describes an example in which the second die 22 that is flat is used. However, it is to be understood that the structure of the second die 22 is not limited. For example, the second die may also have an intermediate die and an upper die arranged around the intermediate die. The upper die and the intermediate die may each be individually brought closer to/farther away from the first die (i.e., be made to open/close) by a raising/lowering mechanism or a hinge member. Also, the structure of the first die and the cavity may be changed as appropriate according to the shape and the like of the cushion.

(4) Also, the example embodiment described above describes an example in which the cushion 4P is integrally molded. In contrast, the seat portion and the supporting portion may be molded separately. Then the seat portion and the supporting portion may be integrally joined by a joining member such as a fastener member or a hook member. The seat portion and the supporting member may also be integrally joined using an adhesive as long as it does not feel much at all like a foreign body to an occupant.

While the invention has been described with reference to example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the scope of the invention.

What is claimed is:

1. A cushion of a vehicle seat, comprising:
a seat portion made of polyurethane foam; and
a supporting portion made of an elastic fiber laminated body,
wherein the seat portion and the supporting portion are directly joined in a state in which the elasticity of the supporting portion is maintained.

2. A manufacturing method of the cushion according to claim 1 using a mold assembly, wherein the mold assembly has a first die and a second die that is able to close together with the first die such that a cavity is formed between the first die and the second die, the manufacturing method comprising:
a first step of arranging the supporting portion in the second die, and pouring liquid polyurethane raw material into the cavity; and
a second step of expanding the liquid polyurethane raw material inside the cavity after closing the first die and the second die together,
wherein in the second step, the liquid polyurethane raw material is away from the supporting portion, and the liquid polyurethane raw material that is expanding contacts the supporting portion, such that the supporting portion and the seat portion become integrated.

3. The manufacturing method according to claim 2, further comprising:
melting and hardening a contact surface of the supporting portion that the expanding liquid polyurethane raw material contacts, before the second step.
